(19) United States
(12) Patent Application Publication
(10) Pub. No.: US 2013/0068557 A1
(43) Pub. Date: Mar. 21, 2013

(54) SYSTEMS AND METHODS FOR INTERFACING TO A GUIDE RAIL

(71) Applicant: Franklin D. Rasmussen, West Bend, WI (US)

(72) Inventor: Franklin D. Rasmussen, West Bend, WI (US)

(73) Assignee: Custom Service Hardware, Inc., Cedarburg, WI (US)

(21) Appl. No.: 13/421,952

(22) Filed: Mar. 16, 2012

Related U.S. Application Data
(60) Provisional application No. 61/453,411, filed on Mar. 16, 2011.

(51) Int. Cl. E06C 9/12; B23P 11/00; E06C 7/00

(52) U.S. Cl. CPC E06C 9/12; E06C 7/00; B23P 11/00
USPC 182/36; 29/428

(57) ABSTRACT

Systems and methods are provided for interfacing to a guide rail. Provided is an improved rail interface wheel is provided including a continuous U-channel formed about a periphery of a puck shaped wheel body. The rail interface wheel is configured to spin about a spin axis. The U-channel includes a primary diameter measured parallel to the spin axis and a secondary diameter measured along a line that is coplanar with but not parallel to the spin axis. The secondary diameter is preferably at least as great as the primary diameter. The rail interface wheel may be used in combination with a movable structure, such as a library ladder.

### RELATED APPLICATION

This application claims the benefit of co-pending U.S. Provisional Patent Application Ser. No. 61/453,411, filed 16 Mar. 2011, and entitled “Systems and Methods for Interfacing to a Guide Rail.”

### BACKGROUND OF THE INVENTION

Embodiments according to the present invention relate generally to supporting a moveable object on a guide rail, and more particularly to systems and methods for interfacing to a guide rail, such as a system for interfacing a rolling ladder to a guide rail.

Many prior devices have been developed for interfacing to a guide rail. Some of the prior art devices for interfacing with a guide rail comprise a hook mechanism. While the hook mechanism allows for easy interfacing and removal, the sliding friction created by any lateral movement makes such movement difficult and inefficient. Other prior art interfacing systems may comprise a wheel mechanism to allow for easy lateral movement. This prior art, however, generally uses a track or channel in which the wheel runs and is contained. As such, with the wheel contained within the mechanism on a guide rail, the moveable object that is supported on the guide rail cannot be easily removed. As such, there remains space in the art for improved systems and methods for interfacing to a guide rail which provide efficient lateral movement yet providing easy interfacing and removal capabilities, while maintaining a secure connection, of the moveable object on the guide rail.

### SUMMARY OF THE INVENTION

The present invention provides improved systems and methods for interfacing to a guide rail.

One aspect of the invention provides a system comprising a longitudinal support rail capable of being coupled to a support structure, the rail having a rail radius; a rail interface mechanism comprising a wheel that is rotatable about a wheel spin axis and configured to interface with the longitudinal support rail, the wheel comprising a body formed about said wheel spin axis, said wheel having an at least partially u-shaped channel formed radially into the body and forming a first flange defining a first flange diameter and a second flange defining a second flange diameter; wherein the channel is configured to receive said longitudinal support rail and is formed about a channel axis, the channel having a channel radius measured from said channel axis.

The system may also provide a support rail that is substantially tubular.

The system may also provide a support rail that has a substantially circular cross section.

The system may also provide a channel that has a primary diameter measured parallel to the wheel spin axis and a secondary diameter measured along a straight line that is coplanar with, but not parallel to, the wheel spin axis, between a point at the end of said first flange and a coplanar point at the end of said second flange, and wherein the secondary diameter is at least as great as the primary diameter.

The system may also provide a channel radius that is greater than or equal to said rail radius.

The system may also provide a channel having a channel axis distance measured radially from said wheel spin axis to the channel axis, wherein the channel axis distance is greater than one-half of said first flange diameter.

The system may also provide a channel axis that is positioned closer to one of said first flange or said second flange.

Another aspect of the invention provides a system having a longitudinal support rail capable of being coupled to a support structure, a movable element to be moved along the support rail, a rail interface mechanism coupled to the movable element, the rail interface mechanism comprising a wheel coupled to the movable element and rotatable about a wheel spin axis, said wheel comprising a body formed about said wheel spin axis, wherein the wheel has an at least partially u-shaped channel formed radially into the body and forming a first flange and a second flange.

The system may also provide a support structure that is a book case.

The system may also provide a moveable element that is a ladder.

The system may also provide a wheel that is directly rotatably coupled to said moveable element.

The system may also provide a surface assembly coupled to said movable element at a location where said movable element meets a support surface, said surface assembly configured to accommodate movement of said movable element along said support surface.

The system may also provide a surface assembly that is a roller assembly.

The system may also provide a wheel that is rotatably coupled to a position adjustment mechanism.

The system may also provide a position adjustment mechanism comprising a mounting bracket configured to be coupled to a moveable element and a slide bracket that is slidably moveable relative to said mounting bracket, and wherein said wheel being rotatably coupled to said slide bracket.

The system may also provide a position adjustment mechanism that has a slide bracket biased in a first position in relation to said mounting bracket.

The system may also provide a slide bracket that is capable of being moved into a second position in lateral relation to said mounting bracket.

The system may also provide a wheel that is coupled to said position adjustment mechanism by a threaded member extending therethrough.

Another aspect of the invention provides a method comprising the steps of providing a system comprising a longitudinal support rail capable of being coupled to a support structure, a movable element to be moved along said support rail, a rail interface mechanism coupled to said movable element, said rail interface mechanism comprising a wheel coupled to said movable element and rotatable about a wheel spin axis, said wheel comprising a body formed about said wheel spin axis, said wheel having an at least partially u-shaped channel formed radially into the body and forming a first flange and a second flange; positioning said wheel in alignment with said longitudinal support rail; placing said wheel on said longitudinal support rail such that said channel receives said support rail, thereby placing the wheel in rotatable engagement with said support rail; and moving said moveable element along said longitudinal support rail.

The method may also provide a channel that has a primary diameter measured parallel to the wheel spin axis, and a secondary diameter measured along a straight line that is coplanar with, but not parallel to, the wheel spin axis, between a point at the end of said first flange and a coplanar point at the end of said second flange, and wherein said secondary diameter is at least as great as the primary diameter.

### BRIEF DESCRIPTION OF THE DRAWINGS

FIG. 1 is a perspective elevation view of a rolling ladder system incorporating embodiments according to the present invention.

FIG. 2 is a partial cutaway perspective view of the embodiment of FIG. 1, including an embodiment of a system for interfacing to a guide rail according to the present invention.

FIG. 3 is a partial assembly view of the embodiment of FIG. 2.

FIG. 4A is a front elevation of an embodiment of a guide wheel according to the present invention.

FIG. 4B is a right side elevation of the guide wheel of FIG. 4A.

FIG. 4C is a rear elevation of the guide wheel of FIG. 4A.

FIG. 5A is a right elevation view of a step of interfacing the guide wheel of FIG. 4A to a guide rail.

FIG. 5B is a right elevation view of the guide wheel of FIG. 5A resting on the guide rail.

FIG. 5C is a right elevation view of the arrangement depicted in FIG. 5B, further depicting adjustment of a system according to the present invention.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

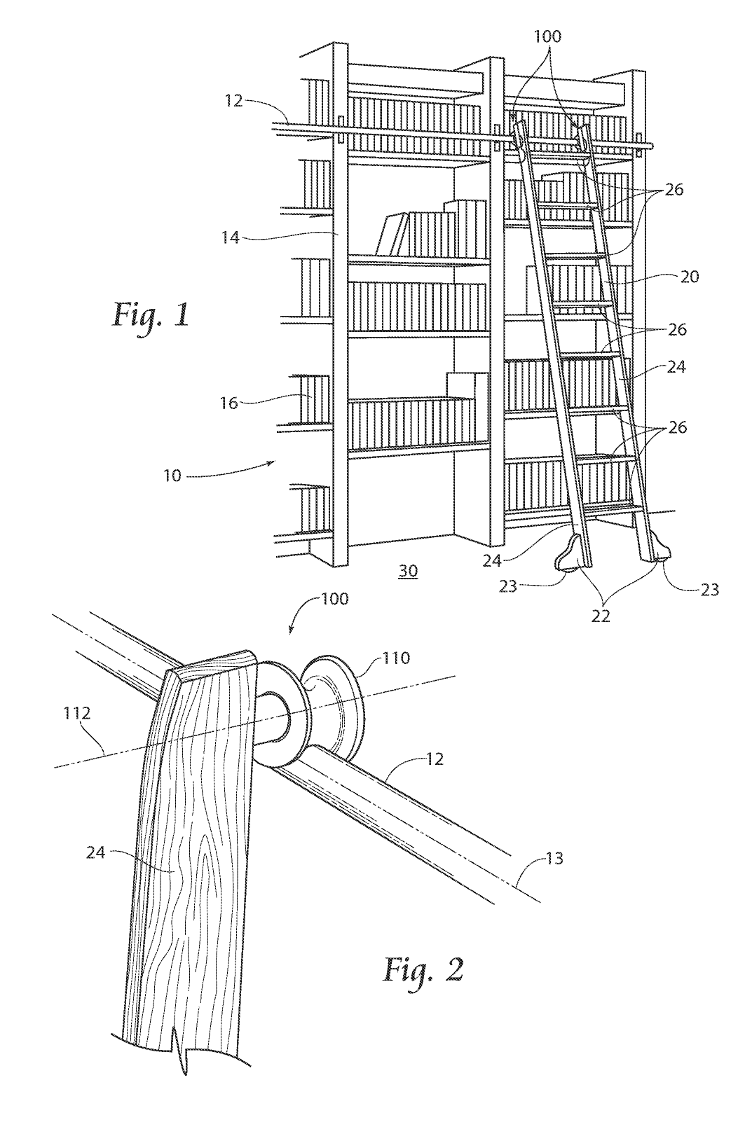

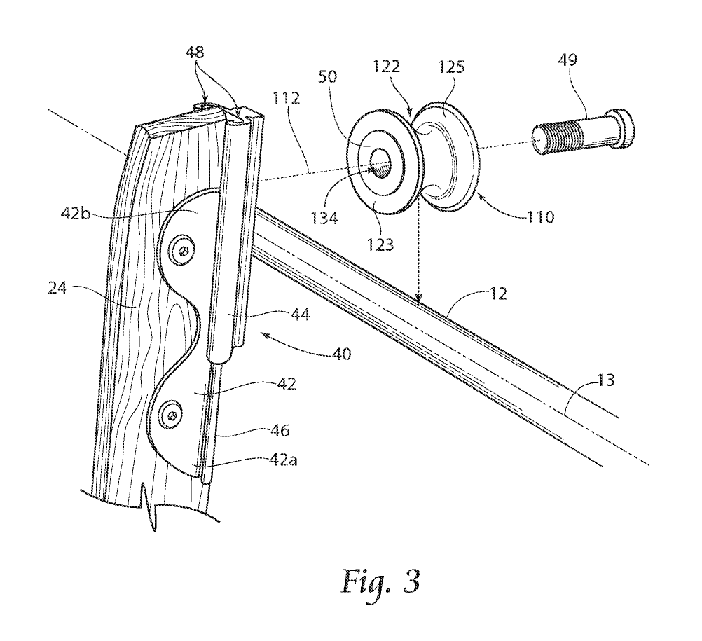

Turning now to the Figures, FIGS. 1 and 2 depict a system 10 according to the present invention. The system 10 includes a longitudinal support rail 12 and a rail interface mechanism 100 to move an object 20 along the rail 12.

The rail 12 may be a tubular or substantially cylindrical member formed along a longitudinal rail axis 13. The rail 12 may be of any desired cross-section, but a substantially circular cross-section, as shown, is preferred. The rail 12 may be attached directly or coupled indirectly to a support structure 14, such as a wall, a doorway, a shelving system 14 as shown, such as a bookshelf adapted to support one or more books 16, or any other structure that can support the rail 12.

The rail interface mechanism 100 may comprise a simple slide hook (not shown) or double roller systems (not shown) as conventionally known in the art. However, a preferred rail interface mechanism 100 includes at least one rail interface wheel 110 coupled to a moveable object, such as ladder 20, a moveable chalkboard or dry erase board, a window covering, or the like. As is generally conventional in the art, a ladder 20 according to the present invention may include a plurality of rails 24 separated by one or more rungs 26. Generally, each rail 24 is supported in a generally vertical plane, but also disposed, in that plane, at an oblique angle to the support surface 30. The rails 24 are preferably at least substantially parallel to each other. Each rung 26 may be supported by one or more rails 24 and positioned generally perpendicular thereto.

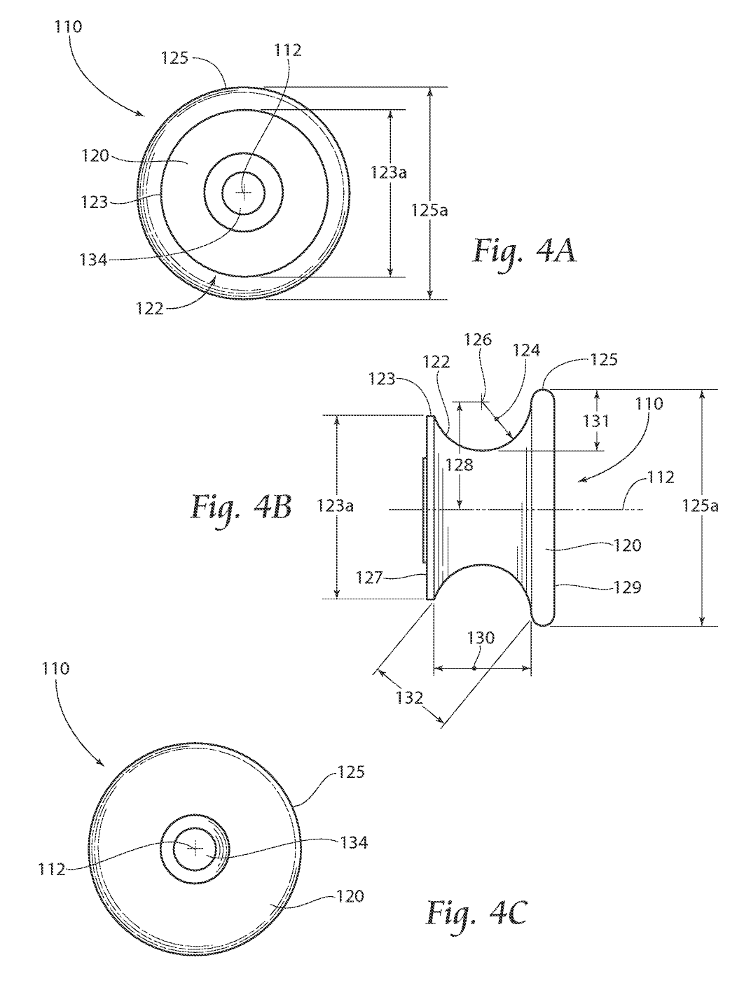

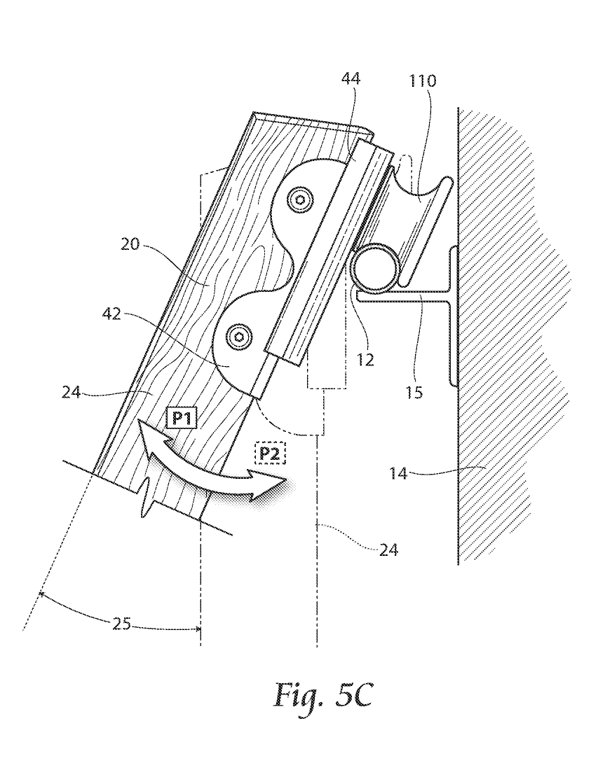

Referring to FIG. 2, the wheel 110 may be rotatably coupled to the moveable object or ladder 20 at a fixed location, such as on the ladder rail 24. FIG. 3 shows an alternative embodiment wherein the wheel 110 may be coupled indirectly to the ladder 20 through a position adjustment mechanism 40, or other structure. The adjustment mechanism 40 may be any mechanism that allows a first element to which the wheel 110 is coupled to move in relation to a second element that is coupled to the moveable object 20. A preferred position adjustment mechanism 40 includes a mounting bracket 42 fixedly connected to a ladder rail 24 and a slide bracket 44 in slidable communication with the mounting bracket 42. The mounting bracket 42 is preferably coupled directly to the ladder rail 24 and has a mating structure, such as mating ridges 46. The mounting bracket extends between a first end 42b and a second end 42a, wherein the second end 42a is positioned closer to a support surface 30, than is the first end. A preferred slide bracket 44 preferably also has a mating structure allowing such slidable communication with the mounting bracket 42, such as mating grooves 48. The position adjustment mechanism 40 may also have a biasing member (not shown), such as a spring, to bias the adjustment mechanism 40 in a first position. The first position is preferably such that the slide bracket 44 is biased in a direction along the ladder rail 24 that is substantially towards the support surface 30. As such, in a first position, shown in FIG. 5A, the slide bracket 44 is positioned substantially toward the second end 42a of the mounting bracket 42. Then, when engaged with the rail 12, the slide bracket 44 moves into an engaged position, shown in FIG. 5B, wherein the slide bracket 44 is positioned substantially toward the first end 42b of the mounting bracket 42. This biased relationship accommodates more secure interfacing between the wheel 110 and rail 12, as the biasing member or spring creates a force to press the wheel 110 onto the rail 12.

As shown in FIG. 3, generally, the wheel 110 may be rotatably mounted to the slide bracket 44, although it may also be mounted directly to the moveable object 20, such as with a threaded member 49 extending through the wheel 110 and into the slide bracket 44 or moveable object 20. A roller bearing 50 may be positioned within the wheel 110 to enhance performance. Otherwise, a standard friction bearing may be established, such as the threaded member 49, itself. The wheel 110 is configured to preferably spin about a wheel axis 112.

The moveable object, such as a ladder 20, may be provided with one or more movement assemblies 22 coupled thereto for at least partially supporting the ladder 20 and any load carried thereby, on a support surface 30, such as a floor, ledge, or other surface. The movement assembly 22 provides for preferably sliding or rolling contact with the support surface 30. As shown in FIG. 1, the movement assembly 22 may comprise a wheel 23 or other roller device coupled directly or indirectly to the moveable object or ladder 20. Alternatively, the movement assembly 22 may have a smooth surface, such as a smooth ski-type assembly (not shown), to accommodate a reduced-friction movement, such as more efficient movement along carpet, or any other configuration which allows the moveable object 20 to move along the support surface 30, in a direction substantially parallel with the longitudinal support rail 12.

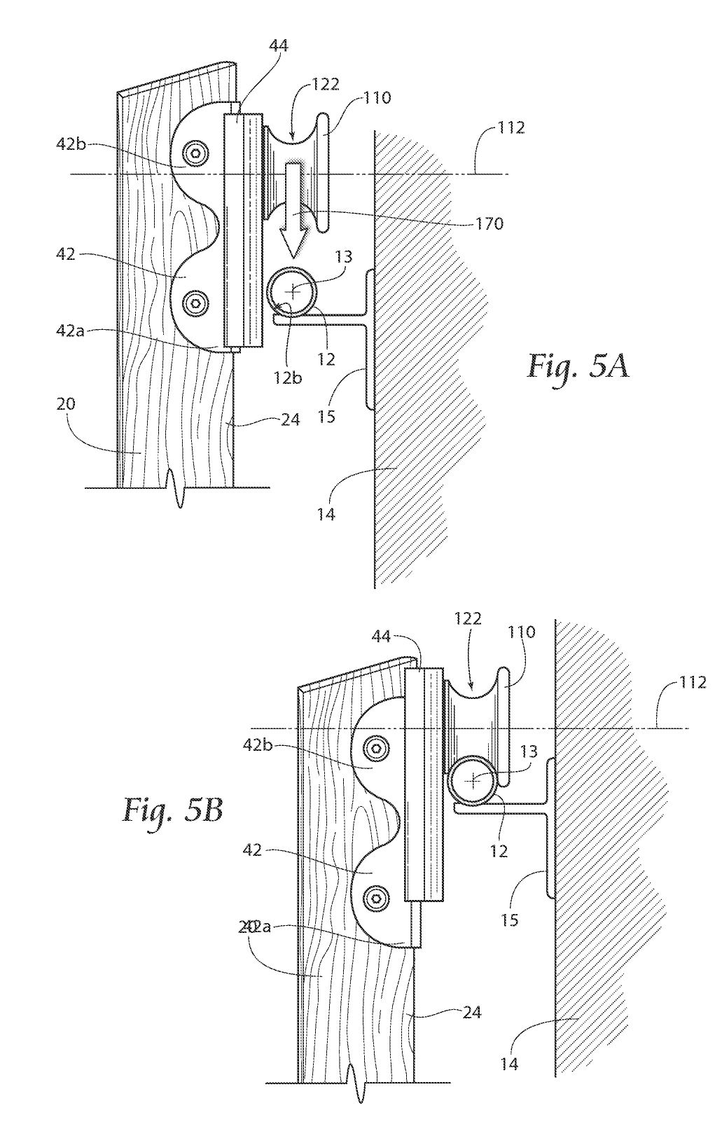

Turning now to FIGS. 4A-4C, an embodiment of a rail interface wheel 110 according to the present invention may be further described. The wheel 110 preferably includes a substantially puck-shaped wheel body 120 formed about the wheel spin axis 112. The wheel body 120 has a first surface 127 oppositely disposed from a second surface 129. Formed along and preferably coaxial with the spin axis 112, through the wheel body 120 and through its first surface 127 and second surface 129 is a mounting aperture 134. Formed into the first surface 127, also preferably coaxial with the mounting aperture 134 may be a bearing cup 136 adapted to receive the roller bearing 50. Formed radially into the wheel body 120, between the first surface 127 and the second surface 129, is a continuous at least partially U-shaped channel 122 extending in towards and about the wheel spin axis 112, the channel 122 separating a first flange 123, having a diameter 123a measured perpendicular to spin axis 112, and a second flange 125, having a diameter 125a, also measured perpendicular to spin axis 112. The channel 122 is formed at a preferred channel radius 124 from a channel axis 126, which is a circular axis disposed at a channel axis distance 128 from the spin axis 112. The channel radius 124 is preferably greater than or equal to the radius 12b of the rail 12 to thereby accommodate the positioning of wheel 110 and channel 122 on the rail 12. The channel axis 126 may be established at a channel axis distance 128 that is greater than one half of the first flange diameter 123a. The channel 122 may be formed radially inward on the wheel body 120 to a channel depth 131, measured perpendicular to the spin axis 112 from the greatest flange diameter 123a, 125a. The channel 122 has a primary diameter 130 that may be measured parallel to the spin axis 112. The primary diameter 130 is preferably greater than or equal to the diameter of the rail 12. The channel 122 preferably also includes a secondary diameter 132 that may be measured along a straight line that is coplanar with, but not parallel with, the spin axis 112, between coplanar outermost points on the first flange 123 and the second flange 125. The secondary diameter 132 is preferably at least as great as the primary diameter 130. One way of rendering such secondary diameter 132 is to form a diameter 123a of the first flange 123, different from, and preferably less than, a diameter 125a of the second flange 125. The longer diameter 125a of the second flange 125 over the first flange 123 accommodates a more secure interfacing between the wheel 110 and the rail 12. In particular, the diameter of the second flange 125 prohibits lateral movement in the direction of the wheel spin axis 112 which may cause the wheel 110 to slip off of the rail 12. This preferred designed of flanges 123 and 125 allows the wheel 110 to act as a hook for secure placement over the rail 12, but also accommodates lower friction movement over the rail 12 by being in the form of a wheel 110.

Further, the channel axis 126 may be positioned closer to either a substantially planar first surface 127 of the wheel body 120 or a substantially parallel, substantially planar second surface 129 of the wheel body 120, thereby disposing the channel 122 closer to either the first surface 127 or the second surface 129. Alternatively, the channel axis 126 may be substantially centered between the first surface 127 and the second surface 129.

Turning now to FIGS. 5A-5C, a method of interfacing to a guide rail according to an embodiment of the present invention may be explained. FIG. 5A depicts a guide rail 12 securely mounted to a support structure 14 through the use of a support bracket 15 or any other mounting device that can secure the rail 12 to a support structure 14. A rail interface wheel 110 has been rotatably coupled to a ladder 20 with a first surface 127 of the wheel body 120 positioned toward the ladder 20 and a second side 128 facing away from the ladder 20. In the embodiment shown, the wheel 110 is coupled to a slide bracket 44, which is mateable with, and moveable in relation to, a mounting bracket 42 that is secured on ladder 20, or moveable object. The wheel 110 is configured to spin about the wheel spin axis 112. The wheel 110, and particularly, channel 122 formed into the wheel body 120 is positioned in alignment with the rail 12 and moved in an engagement direction 170, such as vertically downward, as shown in FIG. 5A. This movement causes the wheel 110 to rest on the rail 12, as shown in FIG. 5B. As the weight of the moveable object 20 pulls down on the mounting bracket 42 and the rail provides a force against wheel 110, the biasing member (if provided) such as a spring, will either compress or stretch, and the slide bracket will move towards the top 42b of the mounting bracket 42. FIG. 5B shows the rail 12 nested in the channel 122 formed into the wheel 110, and the biasing force from the biasing member (not shown) provides secured interfacing between the wheel 110 and the rail 12. In this way, the wheel 110 is allowed to spin about the spin axis 112, and to roll along the rail 12 parallel to the rail axis 13. An advantage provided by the primary and secondary diameters 130, 132 of the channel 122 is a relative ease in engaging the wheel 110 with the rail 12. Once the wheel 110 is engaged with the rail 12, as can be seen in FIG. 5C, the ladder rail 24 may be rotated to a plurality of various positions P1,P2 separated by an oblique angle 25, while engagement of the wheel 110 with the rail 12 is maintained, preferably by the second flange 125 of the wheel 110.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

I claim:

1. A system comprising:
a longitudinal support rail, said rail having a cross-section rail radius,
a rail interface mechanism comprising a wheel rotatable about a wheel spin axis and configured to interface with said longitudinal support rail,
said wheel comprising a body formed about said wheel spin axis, said wheel having an at least partially u-shaped channel formed radially into the body and forming a first flange defining a first flange diameter and a second flange defining a second flange diameter;
wherein said channel is configured to receive said longitudinal support rail; and
wherein said channel is formed about a channel axis, said channel having a channel radius measured from said channel axis.

2. The system of claim 1 wherein said support rail is substantially tubular.

3. The system of claim 1 wherein said support rail has a substantially circular cross section.

4. The system of claim 1 wherein said channel has a primary diameter, wherein said primary diameter includes and is twice the channel radius, wherein said primary diameter is measured parallel to the wheel spin axis, and said channel has a secondary diameter measured along a straight line that is coplanar with, but not parallel to, the wheel spin axis, between a point at a radially outermost point, from said wheel spin axis, of said first flange and a coplanar point at a radially outermost point, from said wheel spin axis, of said second flange, and wherein said secondary diameter is not equal to the primary diameter.

5. The system of claim 4 wherein said secondary diameter is at least as great as the primary diameter.

6. The system of claim 1 wherein said channel radius is greater than or equal to said rail radius.

7. The system of claim 1 further comprising a channel axis distance measured radially from said wheel spin axis to said channel axis, wherein said channel axis distance is greater than one-half of said first flange diameter.

8. The system of claim 1 wherein said channel axis is positioned closer to one of said first flange and said second flange.

9. A system comprising:
a longitudinal support rail,
a movable element to be moved along said support rail,
a rail interface mechanism coupled to said movable element, said rail interface mechanism comprising a wheel coupled to said movable element and rotatable about a wheel spin axis,
said wheel comprising a body formed about said wheel spin axis, said wheel having an at least partially u-shaped channel formed radially into the body and forming a first flange and a second flange.

10. The system of claim 9 wherein said support structure is a book case.

11. The system of claim 9 wherein said moveable element is a ladder.

12. The system of claim 9 wherein said wheel is directly rotatably coupled to said moveable element.

13. The system of claim 9 further comprising a surface assembly coupled to said movable element at a location where said movable element meets a support surface, said surface assembly configured to accommodate movement of said movable element along said support surface.

14. The system of claim 13 wherein said surface assembly is a roller assembly.

15. The system of claim 9 wherein said wheel is rotatably coupled to a position adjustment mechanism, wherein said position adjustment mechanism comprises a mounting bracket configured to be coupled to the moveable element and a slide bracket that is slidably moveable relative to said mounting bracket, and wherein said wheel is rotatably coupled to said slide bracket.

16. The system of claim 15 wherein said slide bracket of said position adjustment mechanism is biased with a bias force towards a first end of said mounting bracket.

17. The system of claim 16 wherein said slide bracket is capable of being moved along, and toward a second end of, said mounting bracket, wherein movement of said slide bracket along said mounting bracket is achieved by placing a radial force on said wheel and wherein said radial force is greater than said bias force.

18. The system of claim 15 wherein said wheel is coupled to said position adjustment mechanism by a threaded member extending therethrough.

19. A method comprising:
providing a system comprising a longitudinal support rail capable of being coupled to a support structure, a movable element to be moved along said support rail, a rail interface mechanism coupled to said movable element, said rail interface mechanism comprising a wheel coupled to said movable element and rotatable about a wheel spin axis, said wheel comprising a body formed about said wheel spin axis, said wheel having an at least partially u-shaped channel formed radially into the body and forming a first flange and a second flange;
positioning said wheel on said moveable element in alignment with said longitudinal support rail;
placing said wheel on said longitudinal support rail such that said channel receives said support rail, thereby placing the wheel in rotatable engagement with said support rail; and
moving said moveable element along said longitudinal support rail.

20. The method of claim 19 wherein said channel has a primary diameter measured parallel to the wheel spin axis, and said channel has a secondary diameter measured along a straight line that is coplanar with, but not parallel to, the wheel spin axis, between a point at the end of said first flange and a coplanar point at the end of said second flange, and wherein said secondary diameter is at least as great as the primary diameter.
